(19) United States
(12) Patent Application Publication
(10) Pub. No.: US 2010/0252451 A1
(43) Pub. Date: Oct. 7, 2010

(54) GAS MONITOR

(76) Inventor: P. RICHARD WARBURTON, SEWICKELY, PA (US)

Correspondence Address: P. Richard Warburton;ChemDAQ Inc., 135 Industry Dr, Pittsburgh, PA, 15275, US

(21) Appl. No.: 12/726,459

(22) Filed: Mar. 18, 2010

Related U.S. Application Data
(60) Provisional application No. 61/165,738, filed on Apr. 1, 2009.

(51) Int. Cl. G01N 27/26

(52) U.S. Cl. 205/779.5; 205/775; 205/780.5; 205/785.5; 205/786.5; 205/781; 204/400

(57) ABSTRACT

Exposure of diffusion limited sensors to target gas concentrations above their range can result in non-linearity and slow recovery times. Applications where both a high concentration and a low concentration need to be measured in succession are problematic if the high concentration gas adversely affects the response of the sensor to low gas concentrations. By employing two sensors, one for high range and one for low range gas concentrations, and a means to isolate the low range sensor from the gas source whenever the concentration exceeds a threshold value as determined by the high range sensor and reengage the low range sensor when the target gas concentration falls below the threshold, allows both the measurement of target gas to high concentrations as well as the high resolution measurement of target gas at low concentrations.

### PRIORITY

This application claims priority from provisional application No. 61/165,738 filed on Apr. 1, 2009.

### FIELD OF THE INVENTION

The present invention relates generally to a means for operating gas sensors over a wide range with high resolution at low concentrations.

### BACKGROUND

Amperometric electrochemical gas sensors are widely used for the detection of toxic gases. These sensors typically provide an output current that is linearly proportional to the gas concentration, the magnitude of the current is usually related to the rate at which the gas can diffuse into the sensor and the oxidation or reduction of the gas at the working electrode into the sensor to produce current, as is described by Faraday's law.

I=ΦnF

Where I is the current (Amps), Φ is the flux of the target gas into the sensor (moles/s), n is the number of electrons in the electrochemical reaction and F is the Faraday constant (F˜96,480 C/mol). The flux is determined by the rate of diffusion of the gas into the sensor, and at steady state the flux can be described by Fick's first law of diffusion, assuming that the concentration of the target gas at the electrode is kept close to zero through the electrochemical reaction.

Φ=δD(Cₒ−Cₑ)

Where δ is the diffusivity of the sensor, i.e. a measure of the ease of gas diffusion into the sensor, D is the gas diffusion coefficient, Cₒ is the steady state concentration of the target gas that the sensor is exposed to and Cₑ is the target gas concentration at the electrode surface.

If the target gas concentration becomes very high, then the kinetics of the electrode reaction at either the working or counter electrodes may become rate limiting and the gas concentration at the electrode Cₑ, will not longer be held near zero by the reaction. Alternatively, even if the electrode kinetics would be fast, the supporting circuitry may be unable to deliver sufficient voltage to drive the electrochemical reactions to completion. If either of these scenarios occur, then the flux and the current will no longer be proportional to the gas concentration, i.e. the sensor response becomes non-linear. In addition, there will be a build up of the gas or its intermediate oxidation/reduction products in the sensor, and the sensor will take a long time to recover back to normal operation (output proportional to gas concentration) once the gas is removed. This problem is well known in the prior art. For example, Kaiser has developed a modified potentiostat circuit to increase the recovery of a sensor exposed to high gas concentrations by optimizing the use of the available potential available to the sensor [U.S. Pat. No. 7,182,845]; however this approach will not solve the problem for exposure to very high concentrations of gas where the gas builds up in the sensor because of slow chemical or electrochemical kinetics.

Another common solution is to modify the sensor by restricting the diffusion barrier, i.e. reduce δ in the equation above, so as to limit the amount of gas that can enter the sensor. This change can be accomplished by adding a membrane or a restriction in the gas path, the more restrictive the diffusion barrier, the lower the diffusivity. The effect of changes to the diffusion barrier on the sensitivity (response signal/gas concentration) of the sensor are well known by those experienced with the design of electrochemical gas sensors; [“Amperometric Gas Sensor Response Times” P. Richard Warburton,* Marcus P. Pagano, Robert Hoover, Michael Logman, Kurtis Crytzer and Yi Jin Warburton; Anal. Chem., 1998, 70 (5), pp 998-1006]. However, reducing the amount of gas entering the sensor adversely affects the resolution of the sensor. The resolution (minimum difference in gas concentration that can be resolved) and the minimum detection limit (lowest concentration of gas that can be detected) of the sensor is typically determined by the noise or drift of the sensor independent of the gas. As a typical rule of thumb, the minimum detection limit of the sensor is the steady-state gas concentration that will produce a current three times the noise/drift ratio of the sensor. In practice though, the detection limit may also be limited by the display characteristics, or the digital sampling properties of instrument and the resolution may vary with the concentration of target gas being detected. For purposes of this disclosure, the minimum detection limit is the resolution at very low gas concentration.

To detect lower concentrations of gas, the diffusivity of the gas path is increased so that more gas can reach the electrode for a given gas concentration, increasing the current and so improving the signal/noise ratio. Increasing the diffusivity will increase the gas flux to the electrode and so limit the maximum gas concentration range that the sensor responds linearly to.

Consequently, there is a trade off in electrochemical sensor design between the minimum detection limit of the sensor and the upper range of the sensor, which in turn depend on the noise in the sensor and the electrode and chemical kinetics of the detection reaction. The diffusivity of the sensor is usually selected to optimize these two parameters. A typical gas sensor with a range of 10 ppm may have a resolution of 0.02 ppm. If the sensor diffusion barrier is changed so that the sensor has a linear range of 1000 ppm, then the resolution may be 2 ppm.

One solution to this problem is to use a potentiometric sensor, i.e. measure the change in potential of the sensor's working electrode in the presence of the analyte compound. The response of a potentiometric sensor is logarithmic with respect to the analyte compound, as described by the well known Nernst Equation, and so the dynamic range is very broad, often many orders of magnitude. One limitation of potentiometric sensors is the logarithmic response because the accuracy of the sensor over a narrow range is correspondingly limited. Therefore, for most applications where the gas concentration needs to be measured with good accuracy, an amperometric sensor, with its linear output will be used rather than the logarithmic potentiometric sensor. Another limitation of potentiometric sensors is the need for fast and reversible electrochemical kinetics in order to obtained meaningful results and thus many gases are not readily amenable to detection using a potentiometric sensor. Lastly, potentiometric sensors often succumb to the adverse effects of impurities.

There are many situations where a wide concentration range needs to be measured, but it is still necessary to be able to detect the gas concentration with high resolution, especially at the low concentrations. A typical example where this wider range is useful occurs during the chemical decontamination, of a room using a toxic gas (e.g. ethylene oxide, hydrogen peroxide, ozone, chlorine dioxide, formaldehyde etc.). The term decontamination includes disinfection and sterilization for the purposes of this disclosure. Very high gas concentrations are required during the decontamination process in order to ensure that potential pathogens are destroyed. These concentrations would be very hazardous to anyone exposed to them. During the decontamination process, there is a need to measure the concentration of the gas for process control to ensure that the decontamination procedure is optimized. Once the decontamination process is complete the gas is removed, and gas detection at much lower levels is required to determine when the room is safe for workers to re-enter.

Using hydrogen peroxide for room decontamination as an example; typical concentrations of hydrogen peroxide used for room decontamination are in the 200 to 1000 ppm range. After decontamination, the hydrogen peroxide is cleared and the atmospheric concentration is monitored to determine when it is safe for people to enter than area. The US Occupational Safety and Health Administration (OSHA) permissible exposure limit (PEL) for hydrogen peroxide, calculated as an 8 hour time weighted average is only 1 ppm [29 CFR 1910.1000 Tb1 Z-1], and thus a sensor used to detect hydrogen peroxide for workplace safety needs to have a sub-ppm resolution. Typical monitors for hydrogen peroxide for workplace safety have a range of 0 to 10 ppm, with a resolution of 0.1 ppm (e.g. the hydrogen peroxide Steri-Trac® monitor from ChemDAQ Inc., Pittsburgh Pa.)

If one of these workplace safety monitors were exposed to several hundred parts per million of hydrogen peroxide, the monitor would be over ranged, and the working electrode may be unable to oxidize or reduce all of the hydrogen peroxide causing a build up of hydrogen peroxide in the electrolyte. If some of the hydrogen peroxide reaches the reference, its potential may change which will cause potentiostat drive circuit to change the bias potential of the working electrode, resulting in high background currents.

Once the hydrogen peroxide containing is removed, the monitor would continue to show a high reading for some time until the sensor had cleared all the excess hydrogen peroxide that had accumulated in the sensor, the reference electrode potential had returned to its normal value and the working electrode had rebiased to its normal operating potential. All these effects result in a large current and during this time, the sensor would be unable to function for the detection of low (<5 ppm) or sub-ppm concentrations of hydrogen peroxide. Conversely, a sensor designed with a range 2000 ppm, would probably have a detection limit of a few parts per million and so would lack the resolution to be able to detect the hydrogen peroxide gas around or below the OSHA PEL. Therefore, a means is required that will allow detection at low concentration with sufficient resolution to provide safety information with a resolution below the OSHA PEL and decontamination process information in the hundreds of ppm hydrogen peroxide concentration.

One solution to this problem has been presented by Matthiessen in U.S. Pat. No. 5,092,980. The method employs means of automatically controlling the sensor diffusion barrier, using a magnetically controlled slider, multiple valve closing openings in the diffusion barrier or piezoceramic or micro-piezoceramic valves that vary the diffusivity of the sensor by varying diffusion path into the sensor. While this solution is elegant, it requires complex mechanical parts to control the gas diffusion and also requires that the sensor be specifically designed for this application. These limitations will greatly add to the cost of any gas detection instrument utilizing this method. It would be preferable to have a simpler method that can be applied to any off-the shelf gas sensor.

Another solution has been developed for pellistor sensors. Pellistors are a type of sensor used to detect combustible gases by measuring the heat of combustion. Exposure of pellistors to very high concentrations of hydrocarbon gases can lead to over heating or soot formation, both of which can adversely affect the sensor's performance. In order to avoid these problems, some manufacturers switch the mode of operation for the pellistor from combustion to thermal conductivity, if the gas concentration exceeds a preset threshold. When the combustible gas component falls below the threshold, the sensor reverts to pellistor operation again. Whereas there are some similarities of this prior art to the present invention in that the sensor is protected at high concentrations, however this method is particular to pellistors. The present invention can be applied to any kind of sensor that is potentially damaged by high concentration exposure.

### BRIEF SUMMARY OF THE INVENTION

A common problem in gas detection is that sensors for the measurement of low concentrations of a target gas are saturated in the presence of a high concentration of the target gas, preventing the correct function of the sensor under subsequent low gas concentration conditions. This invention solves the above problem by employing two sensors, one for high range and one for low ranges gas detection. The invention provides a means wherein the low range sensor provides high resolution detection of the target gas at low concentrations, but the low range sensor is mechanically isolated from the gas being analyzed when the signal from the high range sensor indicates that the concentration is too high for the low range sensor. The low range sensor is then re-exposed to the gas sample when the target gas component falls within the range of the low range sensor.

### FIGURES

FIG. 1 shows a block diagram representing a gas monitor employing both a low and high range sensor

FIG. 1 shows a block diagram representing a gas monitor employing both a low and high range sensor with both sensors in a single flow system

### DESCRIPTION

A sensor module is described that solves the problem described above. Instead of relying on changing the diffusion barrier to a single sensor as in U.S. Pat. No. 5,092,980 which adds complexity and cost, a much simpler solution is described which uses a sample-draw system with two off-the-shelf sensors with the gas flow controlled by conventional solenoid valves.

In gas detection, there are two common modes for gas sampling, so called diffusion mode and sample draw. In diffusion mode, the sensor is positioned directly in the atmosphere or gas sample being measured and the gas enters the sensor by diffusion without any additional mechanical delivery means. In a sample draw system, the sensor is located away from the measurement point and the gas is drawn from the measurement point to the sensor, usually by means of a pump. The sample tube will typically include a flow controller, and may include chemical/particulate filters, driers etc. depending of the need for sample conditioning before the sample reaches the sensor. Both diffusion mode and sample draw mode gas detection monitors are commercially available, and many instruments can be configured to operate in either mode. In the sample draw mode, the output from a diffusion limited sensor still follows the diffusion limited response characteristics outlined above, since the flux of gas entering the sensor or passing through the electrode membrane (for electrochemical sensors) is still limited by diffusion.

In this invention, it is a bulk gas flow that is controlled instead of gas diffusion. Controlling the bulk gas flow has the advantage that the device is much simpler, and can be constructed from readily available components, thus making the device lower cost and less prone to failure.

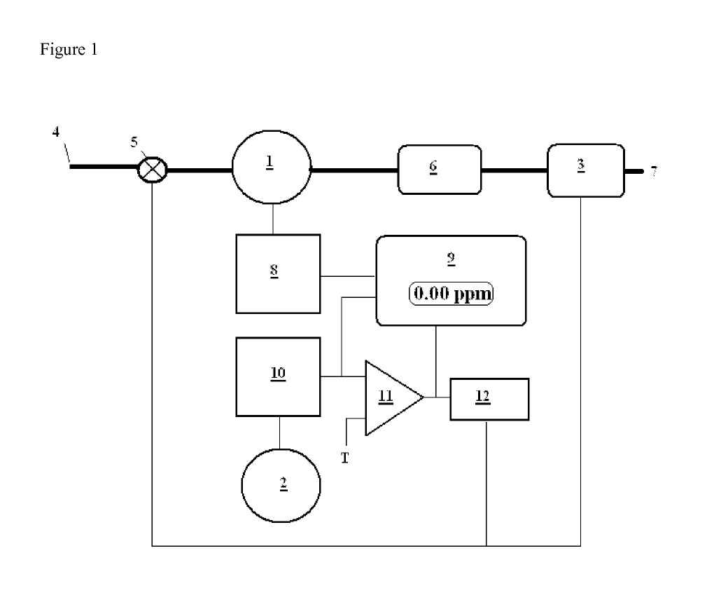

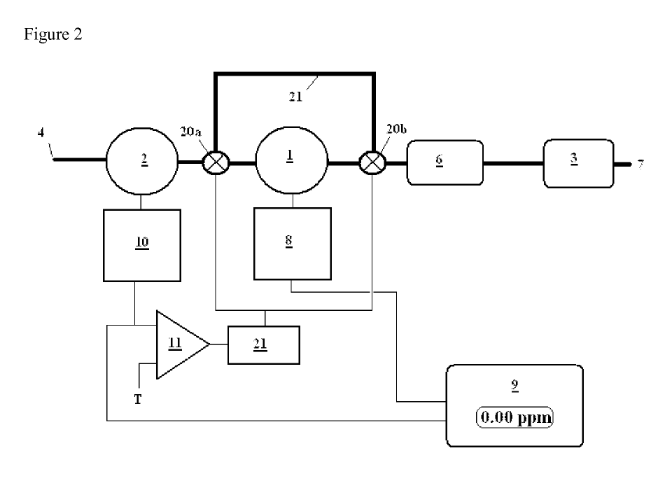

An illustration of how this invention can be implemented in a gas monitoring instrument is shown in FIG. 1. This instrument could be a stand-alone monitor, connected to one or more other gas monitors and data acquisition computers etc. to form a gas monitoring system, or the gas monitor may be integrated as a component into another piece of equipment, such as room decontamination equipment.

The gas monitor in FIG. 1 comprises two conventional gas sensors, 1 and 2. Sensor 1 is designed for measurement of the gas at low concentration range (low range sensor) and sensor 2 is for measurement of the gas at a high concentration range (high range sensor). The low range sensor 1 is part of a gas flow system. Outside air is drawn in by pump 3, through tube 4, valve 5, to the low range sensor 1, through a flow controller 7, and out through the exhaust 7. Valve 5, can open or close the gas line between the inlet tube 4 and the low range sensor 1.

The low range sensor 1 is connected to a sensor drive circuit 8 which provides the bias voltage to operate the sensor 1, and measures and amplifies the current output from the sensor 1. Drive circuits for electrochemical sensors are well known in the prior art, see for example the prior art circuits described by Kaiser in U.S. Pat. No. 7,182,845, Schneider & Scheffler in U.S. Pat. No. 5,366,356 and Galwey in U.S. Pat. No. 4,227,988. Drive circuits for other sensor types are also well known in the prior art. The output from the drive circuit feeds to the gas monitor controller 9. The gas monitor controller 9 provides signal processing, it may display the gas concentration, and provide alarm functions, and communications with other systems (not shown) and other features commonly found in gas monitoring instrumentation. Gas monitor controllers, or components with this functionality, either discrete units or integrated into a gas monitor are well known in the prior art.

The high range sensor 2 in the gas monitor represented in FIG. 1 is exposed to the gas sample being monitored. The high range sensor 2 is also controlled by a conventional drive circuit 10 and the output from the drive circuit also passes to the controller 9. In FIGS. 1 and 2 the heavy black lines represent gas flow paths and the thin black lines represent electrical communications.

The output from the high range drive circuit 10 also passes to a comparator 11. If the output signal from the high range drive circuit 10 is above a threshold, denoted T then the output of the comparator 11 will be logically high. The output of the comparator 11 is connected to a valve/pump circuit 12. If the output of the comparator 11 is logically high then the valve/pump control circuit 12 will turn off the pump 3 and close the valve 5 so as to isolate the low range sensor 1 from the outside gas source. If the output of the comparator 11 is logically low then the valve/pump control circuit 12 will turn on the pump 3 and open the valve 5 so that the low range sensor 1 is exposed to the outside gas sample drawn in through tube 4. The output from the comparator 11 is also preferably connected to the controller 9, so that the controller can determine whether to display the signal from the low range sensor 1 or the high range sensor 2.

Assuming that initially there is little or no target gas in the gas being sampled. The output from the high range sensor 2 will be low, the output from the comparator 11 will be low and so the valve/pump circuit 12 opens valve 5 and turns on pump 3 so that the gas sample is drawn through sample tube 4 and passed to the low range sensor 1. When the output of the comparator 11 is low, then the controller 9 displays a gas reading, triggers alarms, etc. based on the output from the low range sensor 1. The low range sensor 1 provides high resolution output at low target gas concentrations, but is easily saturated at high target gas concentrations. The high range sensor 2 does not have high resolution at low target gas concentrations, but can safety be exposed to high target gas concentrations.

As the target gas concentration increases, the controller 9 will continue to display the high resolution output from the low range sensor 1. If the target gas concentration exceeds the point where the output signal from the high range drive circuit 10 exceeds the threshold T then the output from the comparator 11 will change from logically low to logically high and the valve/pump control circuit 12 will close the valve 5 and turn off the pump 3, thus isolating the low range sensor 1 from the gas being sampled. When the output from the comparator 11 switches from low to high as the signal from the high range sensor drive circuit 10 reaches the threshold T, the controller 9 will display the output signal from the high range sensor 2. Even though the high range sensor 2 does not have the resolution of the low range sensor 1, a high resolution signal is frequently not required when measuring high gas concentrations.

If the outside target gas concentration were to fall, such that the output from the high range sensor drive circuit 10 were to fall below the threshold T, then the output from the comparator 11 would switch from logical high to low, the pump 3 would turn on, the valve 5 would open and the controller 9 would start to display the high resolution reading from the low range sensor 1. Thus the gas monitor shown in FIG. 1 will be able to provide high resolution gas readings at low concentration, provide readings all the way to the high concentration and on lowering the gas concentration, have high resolution readings again at low gas concentrations again without undue wait for the low range sensor 1 to recover.

Other configurations of the plumbing will be apparent to those familiar with the design of gas detection systems in light of this disclosure. For example, the high range sensor 2 could be part of a sample draw gas flow system separate from the low range sensor 1 or part of the same gas flow system. For example, FIG. 2 illustrates how the high range sensor 2 and low range sensor 1 could be plumbed in series down stream of the gas sample line inlet 4, with one or preferably two three-way solenoids 20a and 20b in the gas path both up-steam and down-stream of the low range sensor 1.

When the output from the high range sensor 2 is below the threshold T, the output from the comparator 11 is logically low and the solenoids 20a and 20b allow the gas to flow to the low range sensor 1. When the output from the high range sensor 2 is above the threshold T, the output from the comparator 11 is logically high and valve control circuit 21 causes the solenoids 20a and 20b activate so as to divert the air stream around the low range sensor 1, through the bypass tube 21 and thus isolate and protect the low range sensor 1 from the high target gas concentrations. In such a configuration, the pump 3 would not be deactivated when the low range sensor 1 was protected, since the pump 3 would still be required to draw in gas for the high range sensor 2.

The threshold value is chosen such that it corresponds to a signal from the high range sensor 2 corresponding to a gas concentration below which the low range sensor 1 will operate correctly, and will not be saturated. Typically, this gas concentration will correspond to the maximum of the range of the low range sensor 1, but other values may be selected depending on the gas response properties of the low range sensor 1 and the gas detection application. The selection of the optimum value for the threshold T will apparent to those skilled in the design of gas detection equipment in light of this disclosure.

In this disclosure, the output from the high range sensor 2 is compared to a threshold value T to determine if the value protecting the low range sensor should be opened or closed. In practice, a slightly different threshold will be used to open the valve(s) than to close the valve(s). This hysteresis is employed to prevent oscillation of the valve(s) when the high range sensor signal is close to the threshold value. This use of a small hysteresis is commonly used in feed back control networks and is well known in the prior art. For simplicity, the hysteresis was not included in the description of the present invention but the term threshold value as used herein includes a hysteresis difference between triggering to open the valve(s) and triggering to close the valve(s).

This invention is for sampling a component gas in a gas mixture, wherein the high range and the low range sensors respond to the component gas. The most common example of the gas mixture will be air and the component target gas may be any gas for which there is a suitable sensor. Typically the target gas is a minor component of the gas mixture; thus the gas mixture may be considered a target gas in air balance. For example, the gas mixture may be ppm concentrations of hydrogen peroxide in air. Other gas mixtures, such as compressed air, nitrogen streams or other gases may also be used with this invention, such as ppm concentrations of ammonia in nitrogen balance.

This invention is applicable for any sensors that are adversely affected resulting in saturation, slow recovery times, high background, or inaccurate measurements or combinations of these effects, if the sensor is exposed to concentrations that are very high relative to its range. In particular this invention is applicable to diffusion limited sensors, such as electrochemical sensors, metal oxide sensors and pellistor based sensors as well as other types of sensors. Not all sensors are affected by exposure to gas concentrations beyond their range. For example, most infrared sensors will saturate is exposed to a target gas beyond their range, but they will immediately recover on being exposed to a lower target gas concentration and so would not benefit from this invention.

The terms high concentration and low concentration refer to the concentration of the target gas relative to the range of the sensor. The range of the sensor is the gas concentration over which the sensor is designed to be used. For most sensors whose output is linearly related to gas concentration (e.g. most diffusion limited sensors), the maximum range is the maximum concentration that the sensor output is still linearly proportional to the gas concentration. A hydrogen peroxide sensor for example could be designed to operate with a range of 0 to 20 ppm, resolution of 0.1 ppm, or by changing the diffusion barrier, the sensor could be designed to operate from 0 to 200 ppm, with a resolution of 1 ppm.

In order for the present invention to function correctly, the resolution of the high range sensor must be within the range of the low range sensor. The resolution as used herein is defined as the minimum change in concentration that can be resolved by the sensor. Using the same example with the low range sensor having a range of 0 to 20 ppm, if high range hydrogen peroxide sensor has a resolution of 1 ppm, then the on/off threshold can be set equivalent to 10 ppm and the signal from the high range sensor can be used to turn the low range sensor protection on and off. If however the high range sensor were 0 to 6,000 ppm, with a resolution of 30 ppm, then this sensor would not be suitable for turning the low range sensor protection on and off since the resolution of the high range sensor is outside the range of the low range sensor.

If the range over which the target gas concentration may be encountered is so large that the resolution of the high range is outside the range of the low range sensor, then in another embodiment of this invention, a sensor cascade can be used, with for example three sensors, a low range sensor, range 0 to 20 ppm, a mid-range sensor with range 0 to 2000 ppm, resolution of 2 ppm and the high range sensor with range 0 to 200,000 ppm, with a resolution of 200 ppm. The low range sensor would have protection triggered by the mid range sensor and the mid-range sensor would have similar protection triggered by the high range sensor.

Examples of component gases for which amperometric electrochemical sensors are commercially available include ammonia, carbon monoxide, chlorine, chlorine dioxide, ethylene oxide, formaldehyde, hydrogen, hydrogen chloride, hydrogen cyanide, hydrogen peroxide, hydrogen sulfide, ozone, phosgene, phosphine, nitric oxide, nitrogen dioxide and sulfur dioxide.

Many possible circuits are possible, and will be obvious to those persons skilled and experienced in the design of electrochemical gas sensor control circuits. The block diagrams in FIG. 1 and FIG. 2 are drawn simply in order to aid clarity, but practical implementation of this invention into a gas detection instrument will likely include incorporating this invention with many other functions conventionally used in gas detection instruments. These functions may be developed in either hardware of software, but in the design of modern gas detection instruments, it is likely that some of the functions will be implemented in software or firmware executed by a microprocessor or other digital circuit. FIG. 1 and FIG. 2 also show various functions as discrete blocks, again for clarity, but in practical application it is likely that many of these electronic functions will be combined with other electronic functionality within the same device, circuit board or components, especially if the latter is a programmable component such as a microprocessor, PLC, computer, etc.

If the gas contains components that may potentially damage the pump or flow controller, then a filter (not shown) may optionally be placed in the gas flow system, up-stream of the pump and flow controller. This pump should be selected to remove any gas in the gas stream that can potentially damage the pump. The selection of filter media depends on the nature of the gas or gases in the gas stream and the methods for selection of such filter media are well known to those experienced in the chemical art of filter development.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1) A method for the detection of a target gas in a gas mixture employing at least two gas sensors in a gas detection instrument, wherein one sensor is a high range sensor designed to measure the gas concentration to high concentrations and the second sensor is a low range sensor designed to respond to lower gas concentrations with higher resolution than the said high range sensor; the said method employs the said sensors such that the low range sensor is exposed to the gas being measured when the concentration of the target gas component is low, thus providing a higher resolution gas concentration measurement, but the low range sensor is protected from the gas mixture being measured when the target gas component concentration, as measured by the high range gas sensor, is higher than a threshold value, and the low range sensor is exposed to the gas mixture again whenever the signal from the high range sensor falls below the threshold value.

2) The method of claim 1 wherein the low range sensor is in a sample draw system, but the high range sensor is located such that the gas sample enters the high range sensor by diffusion without the assistance of a pumped gas flow, the gas sample enters the high range sensor by means of a separate sample draw system or the gas sample enters the high range sensor by sample draw system as supplies the low range sensor.

3) The method of claim 1 wherein the gas stream is alternatively directed to the low range sensor or prevented access to low range sensor by means of one or more valves, the operation of said valves is controlled by the output of the high range sensor.

4) The method of claim 4 wherein at least one of the valves is a solenoid valve.

5) The method of claim 1 wherein the sensors are electrochemical amperometric sensors

6) The method of claim 1 wherein the gas mixture is predominantly air

7) The method of claim 1 wherein the target gas is one of the following gases: ammonia, arsine, carbon dioxide, carbon monoxide, chlorine, chlorine dioxide, ethylene oxide, formaldehyde, hydrogen, hydrogen chloride, hydrogen cyanide, hydrogen fluoride, hydrogen peroxide, hydrogen sulfide, ozone, phosgene, phosphine, nitric oxide, nitrogen dioxide, nitrous oxide, silane or sulfur dioxide.

8) The method of claim 1 wherein the said low range sensor is protected from the gas mixture by closing at least one solenoid valve.

9) The method of claim 1 wherein the gas detection instrument is part of a room decontamination system

10) The method of claim 9 wherein the sensor is intended to detect one of the gases from the group hydrogen peroxide, ozone, chlorine dioxide, formaldehyde or ethylene oxide.

11) A device for measuring the concentration of a minor component gas of a gas mixture using at least two gas sensors for the same component gas, the two sensors comprising part of a gas detection instrument, and the said sensors are selected such that they have different ranges, the lower range sensor having higher resolution than the higher range sensor; said device including means for comparing the output signal from the one higher range sensors with a predetermined threshold value, such that the gas mixture access to the low range sensor is interrupted when the output signal from the high range sensor exceeds the said threshold and the gas mixture access to the low range sensor is restored when the output signal from the high range sensor falls below the predetermined threshold.

12) The device of claim 11 wherein the low range sensor is in a sample draw system, but the high range sensor is located such that the gas sample enters the high range sensor by diffusion without the assistance of a pumped gas flow, the gas sample enters the high range sensor by means of a separate sample draw system or the gas sample enters the high range sensor by sample draw system as supplies the low range sensor.

13) The device of claim 11 wherein the gas stream is directed to the low range sensor or the low range sensor is isolated from the gas stream by means of one or more valves, the operation of said valves is controlled by the output of the high range sensor.

14) The device of claim 14 wherein at least one of the valves is a solenoid valve.

15) The device of claim 11 wherein the sensors are electrochemical amperometric sensors

16) The device of claim 11 wherein the gas mixture is predominantly air

17) The device of claim 11 wherein the minor component gas is one of the following gases: ammonia, arsine, carbon dioxide, carbon monoxide, chlorine, chlorine dioxide, ethylene oxide, formaldehyde, hydrogen, hydrogen chloride, hydrogen cyanide, hydrogen fluoride, hydrogen peroxide, hydrogen sulfide, ozone, phosgene, phosphine, nitric oxide, nitrogen dioxide, nitrous oxide, silane or sulfur dioxide.

18) The device of claim 11 wherein the said low range sensor is protected from the gas mixture by closing at least one solenoid valve.

19) The device of claim 11 wherein the gas detection instrument is part of a room decontamination system

20) The device of claim 19 wherein the sensor is intended to detect one of the gases from the group hydrogen peroxide, ozone, chlorine dioxide, formaldehyde or ethylene oxide.
